(19) United States
(12) Patent Application Publication
(10) Pub. No.: US 2004/0263457 A1
(43) Pub. Date: Dec. 30, 2004

(54) METHOD OF IMPROVING A RESPONSE SPEED AND A CONTRAST RATIO OF A LIQUID CRYSTAL DISPLAY

(76) Inventor: Hong-Da LIU, Hsin-Chu Hsien (TW)

Correspondence Address: NAIPO (NORTH AMERICA INTERNATIONAL PATENT OFFICE), P.O. BOX 506, MERRIFIELD, VA, 22116, US

(21) Appl. No.: 10/710,192

(22) Filed: Jun. 24, 2004

(30) Foreign Application Priority Data
Jun. 27, 2003 (TW) 092117615

(51) Int. Cl. G09G 3/36

(52) U.S. Cl. 345/89

(57) ABSTRACT

A method for improving a response speed and a contrast ratio of a liquid crystal display is disclosed. The method includes applying one or more than one voltage within switching times by dividing a scanning period to generate a wanted gray level display state. The voltage to be applied includes a voltage more than a saturation voltage or a voltage that is approximately equal to the saturation voltage. The response speed of the liquid crystal molecules is improved to improve a response speed of the gray level display state. A contrast ratio of the liquid crystal display is improved by adjusting the correlation between the switching times.

### BACKGROUND OF INVENTION

1. Field of the Invention

The present invention relates to a driving method of a liquid crystal display, and more particularly, to a method of improving a response speed and a contrast ratio of a liquid crystal display.

2. Description of the Prior Art

Due to the progress of electronic technology and flourishing development of computer products, the relationship between men and machines becomes more inseparable. Therefore, men rely on machines to process work more than ever. However, a display needs to be utilized to allow men to communicate with a computer. Since the processing technology for fabricating liquid crystal displays has matured recently, and liquid crystal displays have the advantages of low radiation, light weight, and small thickness, liquid crystal displays have gradually replaced cathode-ray tube (CRT) displays. The method in which a liquid crystal display generates its pictures is accomplished by controlling a voltage change within a scanning period T₀ to drive a rotation of liquid crystal molecules in a cell of the liquid crystal display. The liquid crystal display thus produces the wanted picture.

Please refer to FIG. 1 to FIG. 4. FIG. 1 is a transmittance of a normal white liquid crystal display-voltage (T-V) curve. FIG. 2 is a reflectance of a normal white liquid crystal display-voltage (R-V) curve. FIG. 3 is a transmittance of a normal black liquid crystal display-voltage (T-V) curve. FIG. 4 is a reflectance of a normal black liquid crystal display-voltage (R-V) curve. As shown in FIGS. 1-4, a prior art liquid crystal display has a saturated voltage V₀. When the saturated voltage V₀ is applied to the liquid crystal display, the picture of the liquid crystal display becomes completely bright or completely dark. Generally speaking, the picture of the normal white liquid crystal display will become completely dark when applying the saturated voltage V₀, and the picture of the normal black liquid crystal display will become completely bright when applying the saturated voltage V₀. The prior art liquid crystal display utilizes the discrepancy of change of an unsaturated voltage Vⱼ to generate different gray levels Lᵢ. That means, different voltages are utilized to drive a rotation of liquid crystal molecules in a cell of the liquid crystal display. The unsaturated voltage Vⱼ is between 0 V and the saturated voltage V₀, and the unsaturated voltage Vⱼ applied within the scanning period T₀ generates a corresponding gray level Lᵢ. The function satisfying this relation is:

L=L(Vⱼ) (EQ-1)

Please refer to FIG. 5. FIG. 5 is a schematic diagram of applying the unsaturated voltage Vⱼ within the scanning period T₀ according to a prior art liquid crystal display. As shown in FIG. 5, a transistor 14 in the prior art liquid crystal display is conducted to allow the unsaturated voltage Vⱼ to be applied to one cell to generate a corresponding gray level Lᵢ within one scanning period T₀.

In the prior art, the liquid crystal display represents different gray levels according to different applied voltages.

However, the prior art liquid crystal display has a disadvantage of switching gray levels too slowly. Therefore, residual images tend to be generated on the picture. Users are very easily affected by residual images, and may obtain wrong messages when they are utilizing the liquid crystal display. It is therefore very important to provide a method of improving a response speed of a liquid crystal display.

### SUMMARY OF INVENTION

It is therefore a primary objective of the claimed invention to provide a driving method of improving a response speed of a liquid crystal display.

According to the claimed invention, a method for improving a response speed of a liquid crystal display comprises applying one or more than one voltage within a scanning period by a multiple switching means to generate a wanted gray level. The voltage to be applied comprises a voltage more than a saturation voltage or a voltage that is approximately equal to the saturation voltage.

In the processing of a data driving IC, the design complexity of the data driving IC, which is used for controlling the gray level, is affected when the times for turning on and turning off the gate electrode are changed. The area of the data driving IC is thus decreased. Therefore, not only is the design of the data driving IC simplified due to the decreased number of the gray levels to be designed, but also the area of the data driving IC is decreased.

Moreover, the contrast ratio is raised without affecting the gray level response speed.

These and other objectives of the present invention will no doubt become obvious to those of ordinary skill in the art after reading the following detailed description of the preferred embodiment that is illustrated in the various figures and drawings.

### BRIEF DESCRIPTION OF DRAWINGS

FIG. 1 is a transmittance of a normal white liquid crystal display-voltage (T-V) curve.

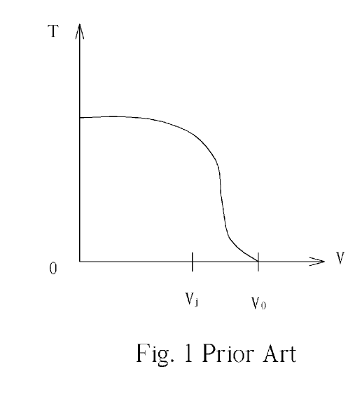

FIG. 2 is a reflectance of a normal white liquid crystal display-voltage (R-V) curve.

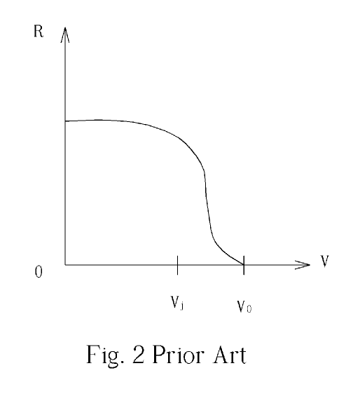

FIG. 3 is a transmittance of a normal black liquid crystal display-voltage (T-V) curve.

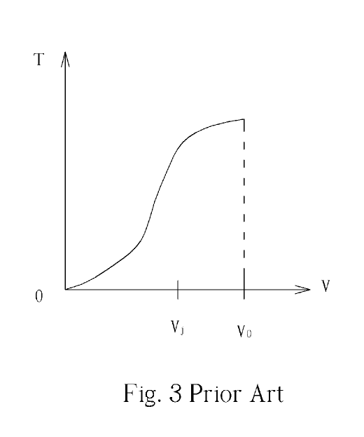

FIG. 4 is a reflectance of a normal black liquid crystal display-voltage (R-V) curve.

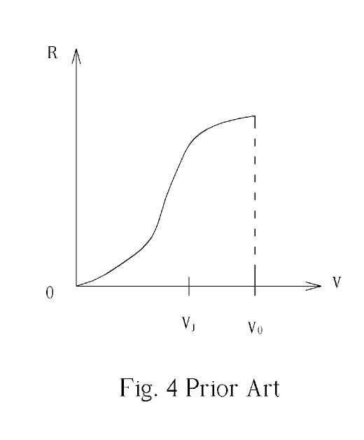

FIG. 5 is a schematic diagram of applying the unsaturated voltage Vⱼ within the scanning period T₀ according to a prior art liquid crystal display.

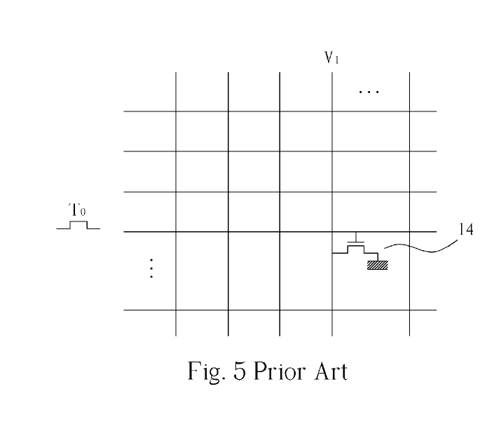

FIG. 6 is a schematic diagram of dividing a scanning period T₀ into a plurality of time segments according to the present invention.

FIG. 7 is a schematic diagram illustrating turning on and turning off the gate electrode during the time segments for the 178^{th} gray level within the scanning period T₀.

FIG. 8 is a schematic diagram illustrating action of gate electrode when the scanning period T₀ is divided into a plurality of time segments according to the present invention.

FIG. 9 is a gray level of a normal white liquid crystal display-voltage curve according to the present invention.

FIG. 10 is a contrast ratio of a normal white liquid crystal display-voltage curve according to the present invention.

FIG. 11 is a schematic diagram illustrating the times for turning on and turning off the gate electrode when dividing a scanning period T₀ into a plurality of time segments to improve the contrast ratio according to the present invention.

### DETAILED DESCRIPTION

The present invention method of improving a response speed of a liquid crystal display involves dividing a scanning period T₀ into a plurality of time segments. By turning on and turning off the gate electrode during the plurality of time segments, one or a plurality of voltages are applied to generate a wanted gray level display state. One or more than one of the applied voltages include voltages more than or approximately equal to the saturated voltage are applied so that a rotation time required by liquid crystal molecules in a cell of the liquid crystal display is shortened. In a better preferred embodiment, an over-saturated voltage is defined for the liquid crystal display, and the over-saturated voltage is not less than the saturated voltage. One or more than one of the applied voltages include the over-saturated voltage.

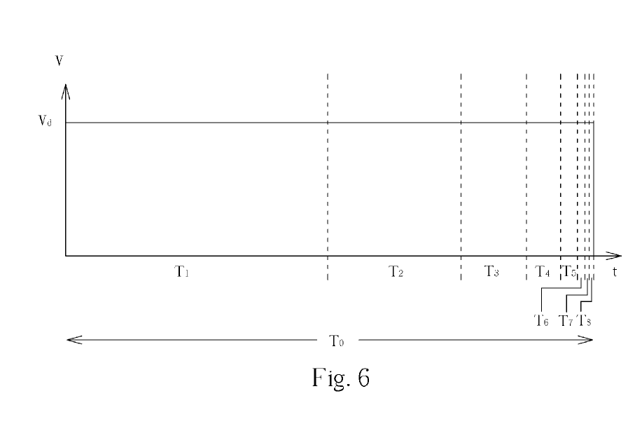

Please refer to FIG. 6. FIG. 6 is a schematic diagram of dividing a scanning period T₀ into a plurality of time segments according to the present invention. As shown in FIG. 6, for example, a liquid crystal display has 256 gray levels including the zeroth order to the 255^{th} order. That means, the scanning period T₀ is divided into 255 equal time units t₀. The scanning period T₀ is then divided into eight time segments by ratios constituting an approximate geometric sequence. The first time segment T₁ is equal to 128 t₀, the second time segment T₂ is equal to 64 t₀, the third time segment T₃ is equal to 32 t₀, the fourth time segment T₄ is equal to 16 t₀, the fifth time segment T₅ is equal to 8 t₀, the sixth time segment T₆ is equal to 4 t₀, the seventh time segment T₇ is equal to 2 t₀, and the eighth time segment T₈ is equal to t₀. In one preferred embodiment, an over-saturated voltage V_{d} is applied in the scanning period T₀, in conjunction with turning on and turning off the gate electrode during the time segments T₁-T₈, to display different gray level states. A sum of the turned on time segment(s) is equal to Tⱼ. The turned on time Tⱼ is between 0 and the scanning period T ₀, and the turned on time Tⱼ is changed according to the change of the gray-level value. Since the over-saturated voltage V_{d} is utilized in this preferred embodiment to speed up a rotation of liquid crystal molecules in a cell of the liquid crystal display, a corresponding gray level Lᵢ is generated by controlling the turned on time Tⱼ within the scanning period T₀. The function satisfying this relation is:

Lⱼ=L(Tⱼ) (EQ-2)

Generally speaking, the method of dividing the scanning period T₀ into a plurality of time segments involves dividing the total number of the gray levels into a sequence and a remainder. Preferentially, the sequence comprises an ordered sequence. In such a preferred embodiment that the remainder is equal to zero, the time segments corresponding to the sequence is applied with the over-saturated voltage V_{d}. Preferentially, the sequence is an approximate geometric sequence. In such a preferred embodiment that the remainder is not equal to zero, the time segments corresponding to the sequence (same as above) is applied with the over-saturated voltage V_{d}, and the time segment corresponding to the remainder is applied with an unsaturated voltage.

A gray level display system including the zeroth order to the 255^{th} order is taken as an example. When the 178^{th} gray level L₁₇₈ is to be displayed, the over-saturated voltage V_{d} is provided, and the turned on time within the scanning period T₀ is T₁₇₈. According to equation EQ-2, the turned on time Tⱼ changes when the gray level Lᵢ changes. When the gray level L₁₇₈ is taken as an example, the turned on time can be expressed as:

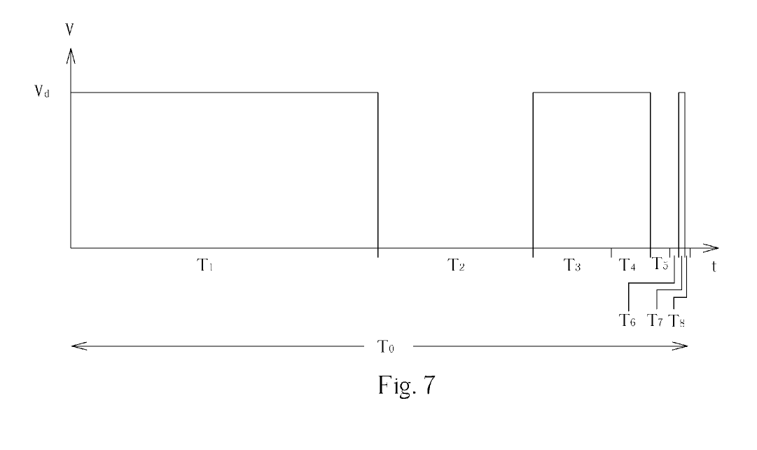

T₁₇₈=178t₀=(128+32+16+2)t₀=T₁+T₃+T₄+T₇ (EQ-3)

where t₀ denotes a time unit, since 178 is equal to the sum of 128, 32, 16, and 2, and 128, 32, 16, and 2 are from a sequence. According to equation EQ-3, the time segments T₁, T₃, T₄, and T₇ are turned on to make the turned on time become T₁₇₈(also 178t₀). Please refer to FIG. 7. FIG.7 is a schematic diagram illustrating turning on and turning off the gate electrode during the time segments for the 178^{th} gray level within the scanning period T₀. As shown in FIG. 7, applying the over-saturated voltage V_{d} and turning on the gate electrode during the time segments T₁, T₃, T₄, and T₇ will achieve the gray level L₁₇₈.

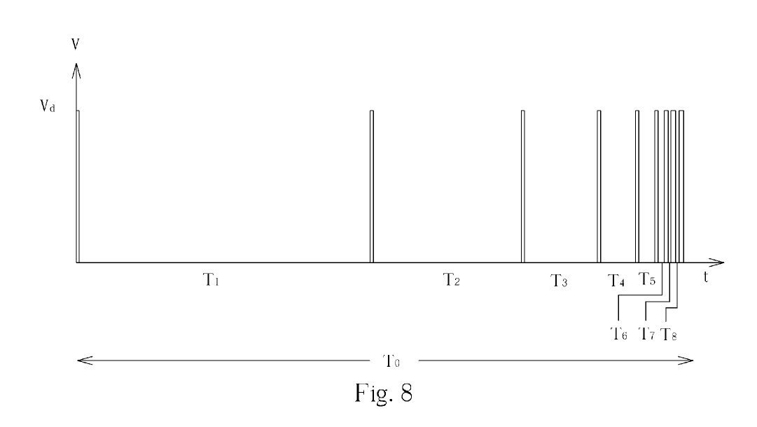

Please refer to FIG. 8. FIG. 8 is a schematic diagram illustrating action of gate electrode when the scanning period T₀ is divided into a plurality of time segments according to the present invention. For a gray level display system including the zeroth order to the 255^{th} order, the gate electrode is turned on or turned off at the beginning of each of the time segments T₁-T₈ to allow the voltage applied to the liquid crystal molecules to be zero or the over-saturated voltage V_{d} within each of the time segments T₁-T₈.

Another method of improving a response speed of a liquid crystal display according to the present invention involves dividing a time corresponding to a gray level display state into a first time and a second time, and to divide the second time into a plurality of time segments. By turning on and turning off the gate electrode during the plurality of time segments, and applying an unsaturated voltage in the first time and an over-saturated voltage V_{d} in the second time, a wanted gray level display state is generated. The applied unsaturated voltage is approximately equal to 60% of the saturated voltage or more than 60% of the saturated voltage, and the over-saturated voltage V_{d} is not less than the saturated voltage. The method of dividing the second time into a plurality of time segments involves dividing the second time by ratios constituting a sequence, such as an ordered sequence or a geometric sequence. The times for turning on and turning off the gate electrode A, according to this preferred embodiment, is less than the times for turning on and turning off the gate electrode B, when only dividing a scanning period T₀ into a plurality of time segments, for improving the response speed of the liquid crystal display. Therefore, the design for controlling the action of gate electrode is simplified.

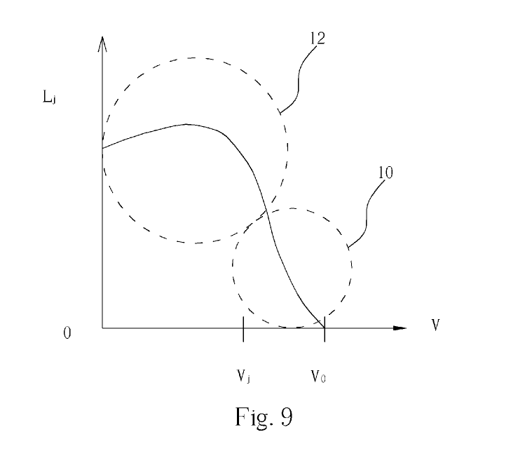

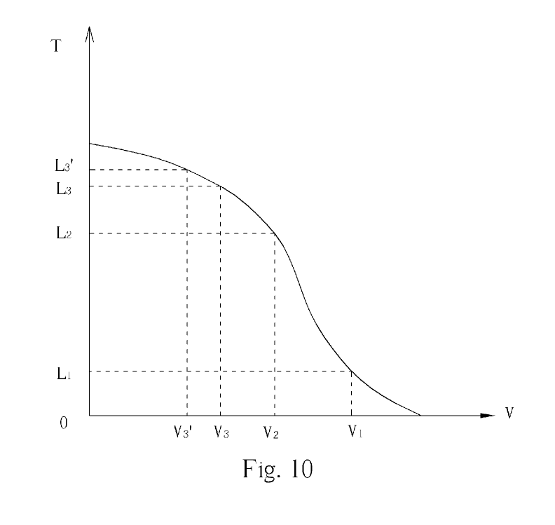

Please refer to FIG. 9. FIG. 9 is a gray level of a normal white liquid crystal display-voltage curve according to the present invention. If the gray level to be switched and displayed is in a gray level quick response region 10, which typically has an unsaturated voltage Vⱼ between ⅔V₀ and V₀, the rotation of the liquid crystal molecules in the cell of the liquid crystal display is very quick due to the high unsaturated voltage Vⱼ in the gray level quick response region 10, as shown in FIG. 10. Therefore, the unsaturated voltage Vⱼ corresponding to the gray level is directly applied, and the method and time for applying the unsaturated voltage Vⱼ is the same as the prior art. Oppositely, if the gray level to be switched and displayed is in a gray level slow response region 12, which typically has an unsaturated voltage Vⱼ between 0 V₀ and ⅔V₀, the rotation of the liquid crystal molecules in the cell of the liquid crystal display is very slow due to the low unsaturated voltage Vⱼ in the gray level slow response region 12. Therefore, the scanning period is divided into a plurality of time segments to control the turned on time Tⱼ of the plurality of time segments, as mentioned previously, when the over-saturated voltage V_{d} is applied in the gray level slow response region 12.

In order to keep the advantage of quick response of the gray level, the voltage applied in the gray level quick response region 10 is between ⅔V₀ and V₀, according to another preferred embodiment of the present invention. However, the scanning period is divided into a plurality of time segments in the gray level slow response region 12 to control the turned on time Tⱼ of the plurality of time segments in the gray level slow response region 12 so that the over-saturated voltage V_{d} is applied within the turned on time Tⱼ. A total number of the gray level is equal to a sum of the highest level controlled by the gray level quick response region 10 and the highest level controlled by the gray level slow response region 12. In the following, the gray level display system including the zeroth order to the 255^{th} order is taken as an example, the controllable levels in the gray level quick response region 10 is from the zeroth order to the 15^{th} order, and the controllable levels in the gray level slow response region 12 is from the 16^{th} order to the 255^{th} order. The scanning period in the gray level slow response region 12 is thus divided into 240(=256−16) time units t₀. The scanning period in the gray level slow response region 12 is then divided into a sequence, such as an ordered sequence constituted by 128t₀, 64t₀, 32t₀, and 16t₀. When the 178^{th} gray level is taken as an example, the magnitude of the voltage is controlled between ⅔V₀ and V₀ in the gray level quick response region 10, and the turned on time Tⱼ of the time segments is controlled in the gray level slow response region 12 to achieve the 178^{th} gray level.

Please refer to FIG. 10. FIG. 10 is a contrast ratio of a normal white liquid crystal display-voltage curve according to the present invention. As shown in FIG. 10, the gray level L₁ is generated by the voltage V₁, the gray level L₂ is generated by the voltage V₂, and the gray level L₃ is generated by the voltage V₃. Contrast ratio (CR) is a ratio of the brightness of one gray level to the brightness of another different gray level. As shown in FIG. 10, the contrast ratio is defined as:

CR₃₁=L₃/L₁ (EQ-4)

In order to increase the contrast ratio or improve the brightness, the gray level L₃ is lifted to the gray level L₃″, and the corresponding voltage V₃ is reduced to V₃″, according to equation EQ-4. Since the gray level L₃″ is higher than the gray level L₃, the brightness is thus improved when the gray level L₁ is not changed. Because the gray level response speed is decreased owing to the reduced voltage, the scanning period T₀ is divided into a plurality of time segments to control the turned on time Tⱼ of the plurality of time segments and a voltage V which is not less than the saturated voltage V₀ or between ⅔V₀ and V₀ is applied, when controlling the gray level response speed. The gray level response speed is thus improved.

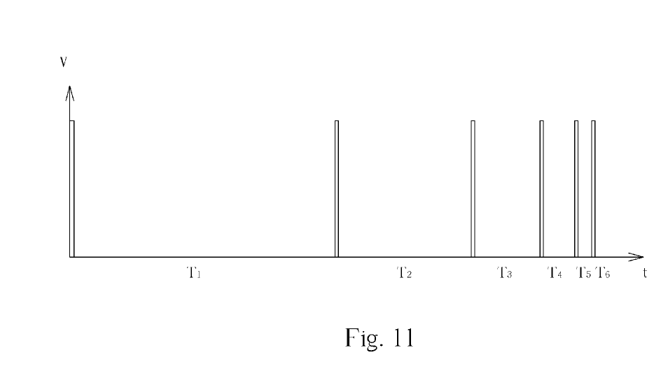

Please refer to FIG. 11. FIG. 11 is a schematic diagram illustrating the times for turning on and turning off the gate electrode when dividing a scanning period T₀ into a plurality of time segments to improve the contrast ratio according to the present invention. For a gray level display system having 64 gray levels, the scanning period is divided into 63 time units t₀ first, then is divided into a plurality of time segments. For example, T₁ is 32t₀, T₂ is 16t₀, T₃ is 8t₀, T₄ is 4t₀, T₅ is 2t₀, T₆ is t₀. That means,

T₀=63t₀=(32+16+8+4+2+1)t₀ (EQ-5).

By controlling the turned on time Tⱼ of the time segments, the contrast ratio is increased without affecting the gray level response speed. In addition, the time units of the time segment corresponding to less time units can be increased in conjunction with decreasing the time units of the time segment corresponding to more time units, when fulfilling equation EQ-5. For example, T₁″ is 0.8×32t₀, T₂″ is 0.9×16t₀, T₃″ is 8t₀, T₄ ″ is 4t₀, T₅″ is 4.2×2t₀, T₆″ is 2.6×t ₀. That means,

T₀=63t₀=(0.8×32+0.9×16+8+4+4.2×2+2.6×1)t₀ (EQ-6).

According to the time segments divided by EQ-5, T₁ is 32/63T₀, T₂ is 16/63T₀, T₃ is 8/63T₀, T₄ is 4/63T₀, T₅ is 2/63T₀, T₆ is 1/63T₀. The time segments divided by EQ-5 can be adjusted to the time segments divided by EQ-6, T₁″ is 25.6/63T₀, T₂″ is 14.4/63T₀, T₃″ is 8/63T₀, T₄″ is 4/63T₀, T₅″ is 8.4/63T₀, T₆″ is 2.6/63T₀. Generally speaking, the design principle for dividing the time segments involves shortening the time segments to occupy more time units t ₀, or elongating the time segment to occupy less time units t₀, or shortening the time segments to occupy more time units t₀ and elongating the time segment to occupy less time units t₀.

In order to improve the contrast ratio, the unsaturated voltage Vⱼ, which is between ⅔V₀ and V₀, is applied in the gray level quick response region 10, in conjunction with adjusting the time segments to control the turned on time so that the times for turning on and turning off the gate electrode is reduced.

In the processing of a data driving IC, the design complexity of the data driving IC, which is used for controlling the gray level, is affected when the times for turning on and turning off the gate electrode are changed. The area of the data driving IC is thus decreased. Therefore, not only is the design of the data driving IC simplified due to the decreased number of the gray levels to be designed, but also the area of the data driving IC is decreased. In addition, the contrast ratio is raised without affecting the gray level response speed.

Those skilled in the art will readily observe that numerous modifications and alterations of the device may be made while retaining the teachings of the invention. Accordingly, the above disclosure should be construed as limited only by the metes and bounds of the appended claims.

1-13. (cancelled)

14. In an information processing system, having a plurality of modules including a processor, a cache memory, a main memory and a plurality of I/O devices, a data streamer for performing data transfer operations between said modules comprises:
a channel state memory configured to store a first allocated channel information, including data addresses, corresponding to a data transfer operation from a source module to said data streamer, and further configured to store a second allocated channel information, including data addresses, corresponding to said data transfer operation from said data streamer to a destination module;
a buffer memory allocated to said data transfer operation for receiving data provided by said source module in accordance with said first allocated channel information and providing said received data to said destination module in accordance with said second allocated channel information; and
a buffer state memory configured to store a relationship which determines that said first channel information and said second channel information and said buffer memory is used in said data transfer operation.

15. The data streamer in accordance with claim 14 wherein said channel state memory stores information corresponding to a plurality of data transfer operations between said modules.

16. The data streamer in accordance with claim 14, wherein a buffer memory is allocated for each one of said data transfer operations and the size of said buffer memory variably changes in accordance with the size of data in a corresponding data transfer operation.

17. The data streamer in accordance with claim 16 wherein the data transfer rate from a source module to a corresponding buffer in said buffer memory, is different than the data transfer rate from said buffer memory to a destination module.

18. The data streamer in accordance with claim 17 wherein said first allocated channel information includes a first channel descriptor, wherein said data transfer operation from a source module to said buffer is accomplished in accordance with said first channel descriptor.

19. The data streamer in accordance with claim 18, wherein said second allocated channel information includes a second channel descriptor, wherein said data transfer operation from said buffer to said destination module is accomplished in accordance with said second channel descriptor.

20. In an information processing system, having a plurality of modules including a processor, a cache memory, a main memory and a plurality of I/O devices, a data streamer for performing data transfer operations between said modules comprises:
a channel state memory configured to store a first allocated channel information, including a first channel descriptor, wherein said data transfer operation from a source module to said buffer is accomplished in accordance with said first channel descriptor, said first channel information corresponding to a data transfer operation from a source module to said data streamer, and further configured to store a second allocated channel information, including a second channel descriptor, wherein said data transfer operation from said buffer to said destination module is accomplished in accordance with said second channel descriptor, said second channel information corresponding to said data transfer operation from said data streamer to a destination module, said first and said second channel descriptors having a different format and wherein the data transfer rate from a source module to a corresponding buffer in said buffer memory, is different than the data transfer rate from said buffer memory to a destination module; and
a buffer memory allocated to each one of said data transfer operation for receiving data provided by said source module in accordance with said first allocated channel information and providing said received data to said destination module in accordance with said second allocated channel information, and wherein the size of said buffer memory variably changes in accordance with the size of data in a corresponding data transfer operation.

21. The data streamer in accordance with claim 14 wherein said data transfer operation from a source module to a destination module includes a data cache operation having a coherent allocation policy.

22. The data streamer in accordance with claim 14 wherein said data transfer operation from a source module to a destination module includes a data cache operation having a coherent no-allocation policy.

23. The data streamer in accordance with claim 14 wherein said data transfer operation from a source module to a destination module includes a data cache operation having a non-coherent no-allocation policy.

24-32. (cancelled)

33. In an information processing system, having a plurality of modules including a processor, a cache memory, a main memory and a plurality of I/O devices, a method for performing data transfer operations between said modules comprising the steps of:
storing a first allocated channel information, including data addresses corresponding to a data transfer operation from a source module to a buffer memory;
storing a second allocated channel information, including data addresses, corresponding to said data transfer operation from said buffer memory to a destination module;
receiving data provided by said source module in accordance with said first allocated channel information;
providing said received data to said destination module in accordance with said second allocated channel information; and
storing a relationship in a buffer state memory which determines that said first channel information and said second channel information and said buffer memory is used in said data transfer operation.

34. The method in accordance with claim 33 further comprising the step of storing a plurality of said channel information each of which corresponding to a data transfer operation.

35. The method in accordance with claim 34, further comprising the step of allocating a buffer memory space within said buffer memory, and changing the size of said buffer memory space in accordance with the size of data in a corresponding data transfer operation.

36. The method in accordance with claim 35 further comprising the step of setting the data transfer rate from a source module to a corresponding buffer memory space at a different rate than the data transfer rate from said buffer memory space to a destination module.

37. The method in accordance with claim 36, further comprising the step of transferring data in accordance with a predetermined channel descriptor.

38. The method in accordance with claim 37 data streamer in accordance with claim 14 wherein said data transfer operation from a source module to a destination module includes a data cache operation having a coherent allocation policy.

39. The data streamer in accordance with claim 33 further comprising the step of providing data transfers having a data cache operation with a coherent no-allocation policy.

40. The data streamer in accordance with claim 33 further comprising the step of providing data transfers having a data cache operation with a non-coherent no-allocation policy.

41-67. (cancelled).

68. In an information processing system, having a plurality of modules including a processor, a cache memory, a main memory and a plurality of I/O devices, a method for performing data transfer operations between said modules comprising the steps of:
storing a first allocated channel information, including a first channel descriptor, wherein said data transfer operation from a source module to said buffer is accomplished in accordance with said first channel descriptor, said first channel information corresponding to a data transfer operation from a source module to a buffer memory;
storing a second allocated channel information, including a second channel descriptor, wherein said data transfer operation from said buffer to said destination module is accomplished in accordance with said second channel descriptor, said second channel information corresponding to said data transfer operation from said buffer memory to a destination module, said first and said second channel descriptors having a different format;
receiving data provided by said source module in accordance with said first allocated channel information; and
providing said received data to said destination module in accordance with said second allocated channel information, wherein the data transfer rate from a source module to a corresponding buffer in said buffer memory, is different than the data transfer rate from said buffer memory to a destination module and wherein the size of said buffer memory variably changes in accordance with the size of data in a corresponding data transfer operation.
